(19) United States
(12) Patent Application Publication
(10) Pub. No.: US 2018/0336603 A1
(43) Pub. Date: Nov. 22, 2018

(54) RESTAURANT REVIEW SYSTEMS

(71) Applicant: FUJITSU LIMITED, Kawasaki-shi (JP)

(72) Inventors: I-Hong JHUO, Sunnyvale, CA (US); Wei-Peng CHEN, Fremont, CA (US)

(73) Assignee: FUJITSU LIMITED, Kawasaki-shi (JP)

(21) Appl. No.: 15/601,978

(22) Filed: May 22, 2017

(51) Int. Cl. G06Q 30/02; G06Q 50/12; G06N 3/08; G06N 3/04; G06T 11/60; G06K 9/62; H04N 7/18

(52) U.S. Cl. CPC G06Q 30/0282; G06Q 50/12; G06N 3/08; G06F 17/30268; G06T 11/60; G06K 9/6202; H04N 7/183; G06N 3/04

(57) ABSTRACT

A method of generating review data associated with a restaurant is provided. A method may include detecting a dish including at least one menu item served to one or more customers in a restaurant. The method may further include receiving visual data including at least one of an image and a video of the dish after the one or more customers have finished eating the at least one menu item at the restaurant and generating a model for the dish based on the received visual data. The method may also include determining a score for the at least one menu item based on a comparison of the generated model to one or more other stored models and generating one or more reviews for the at least one menu item based at least partially on the determined score for the at least one menu item.

### FIELD

The embodiments discussed herein relate to restaurant review systems.

### BACKGROUND

Restaurant reviews, which are typically based on user feedback and/or opinions of expert food critics, may be insufficient and/or inaccurate due to limited amounts of data and/or biased opinions.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method may include detecting, via at least one processor, a dish including at least one menu item served to one or more customers in a restaurant. The method may further include receiving, at the at least one processor, visual data including at least one of an image and a video of the dish after the one or more customers have finished eating the at least one menu item at the restaurant. Moreover, the method may include generating, via the at least one processor, a model for the dish based on the received visual data. The method may also include determining, via the at least one processor, a score for the at least one menu item based on a comparison of the generated model to one or more other stored models associated with the at least one menu item. The method may also include generating, via the at least one processor, one or more reviews for the at least one menu item based at least partially on the determined score for the at least one menu item.

The object and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 is a block diagram of an example review system;

FIG. 2 illustrates an example system including visual data and textual data;

FIG. 3 is another illustration of an example review system;

FIG. 4 is a diagram of an example flow that may be used to determine a loss function for determining a relationship between visual data and textual data;

FIG. 5 shows an example flow diagram of a method of generating one or reviews of a restaurant and/or one or more menu items served at the restaurant; and

FIG. 6 is a block diagram of an example computing system.

### DESCRIPTION OF EMBODIMENTS

The embodiments discussed herein relate to restaurant review systems. The term “restaurant” as used herein may include any establishment where menu items (e.g., food and/or drink) are served to customers. According to some embodiments disclosed herein, a restaurant review system may be configured to analyze visual data generated via one or more videos and/or images collected from surveillance cameras and possibly textual data generated via a point of sale. Further, the restaurant review system may be configured to generate statistical information, such as a list of most popular foods at the restaurant, based on the visual data and/or the textual data.

In contrast to existing review systems that rely on user feedback, embodiments disclosed herein may include an automatic multi-modality analysis system for generating data that may be used for generating one or more reviews. More specifically, in some embodiments, data from one or more modalities may be used to generate one or more reviews of a restaurant and/or one or more menu items served by the restaurant. For example, one modality may include a visual detection system (e.g., including one or more surveillance cameras within a restaurant) configured for generating visual data, and another modality may include a point of sale system configured for generating textual data.

Further, various embodiments may relate to generating data for one or more menu items in a restaurant based on food surplus (e.g., detected after a customer has finished eating the one or more menu items), a rate of consumption of the one or more menu items, one or more emotions of a customer while eating the one or more menu items, and/or wait times to receive the one or more menu items (e.g., from being seated and/or from ordering). In addition, data for one or more menu items may be generated based on whether or not a customer takes uneaten portions out of the restaurant. More specifically, leftovers on a table may be detected, and information related to leftovers, such as how much of menu item is leftover and/or whether or not a customer takes the leftovers out of the restaurant, may be used in generating data for the one or more menu items. According to some embodiments, data for the one or more menu items may be used for generating one or more reviews for the one or more menu items and/or a restaurant that serves that one or more menu items.

Moreover, a customer's age may be estimated, and may be used in generating data (e.g., one or more reviews) for one or more menu items. For example, generated data may vary based on an age of a customer. For example, in some embodiments, a review including a list of most popular menu items (e.g., preferences) for a first age group (e.g., seniors) may be generated, and another review including a list of most popular menu items (e.g., preferences) for another age group (e.g., teens) may be generated.

Further, in some embodiments, data including one or more reviews for the one or more menu items (e.g., a listing/ranking of most popular menu items (e.g., by age group), wait times, customer satisfaction, etc.) may be stored in a database (e.g., the restaurant's database). The data may be used by the restaurant for various purposes, such as marketing and/or decisions regarding menu, menu item portion sizes, and/or menu item pricing.

Embodiments of the present disclosure will be explained with reference to the accompanying drawings.

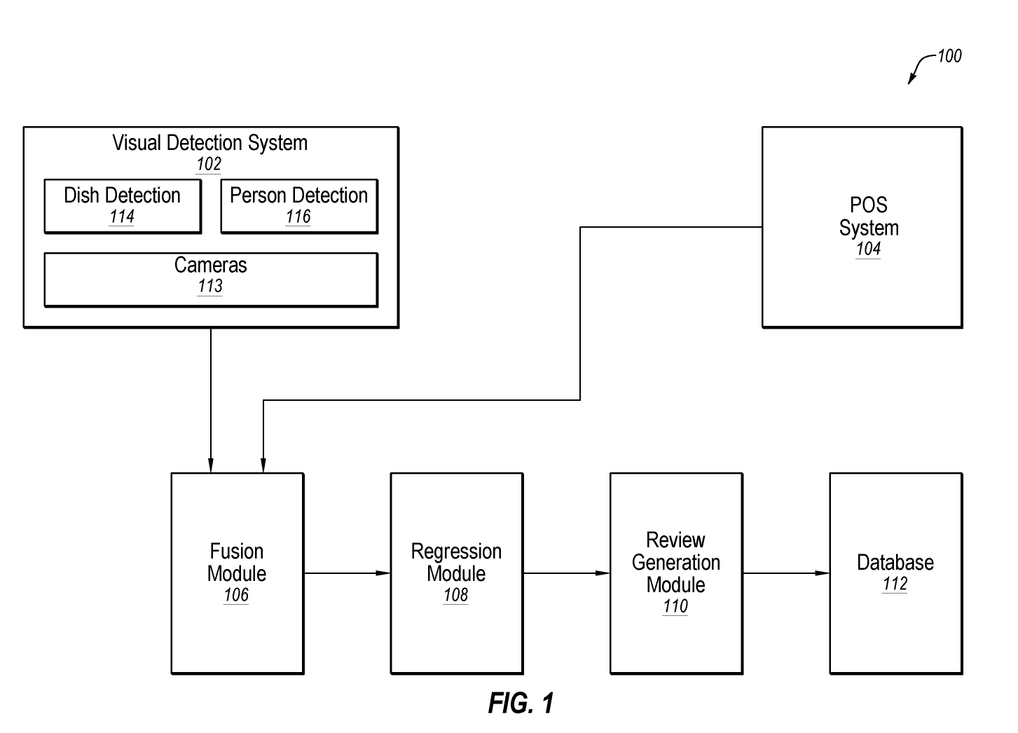

FIG. 1 depicts an example review system 100, arranged in accordance with at least one embodiment described herein. System 100 includes a visual detection system 102, a point of sale (POS) system 104, a fusion module 106, a regression module 108, and a review generation module 110. Further, system 100 may include a database 112, which may store data, such as one or more reviews of a restaurant and/or reviews of menu items served by the restaurant.

Visual detection system 104, which may be configured to generate visual data, may include a dish detection system 114 and a person detection system 116. In some embodiments, visual detection system 104 may include one or more cameras 113 positioned in a restaurant. Visual detection system 104 may further include one or more encoders (e.g., video encoders) for processing video captured via one or more cameras 113.

According to various embodiments, dish detection system 114 may be configured to receive video data and/or image data (e.g., one or more video frames) (e.g., from one or more cameras) and detect and identify one or more menu items (e.g., food dishes) on a restaurant table. For example, dish detection system 114 may be configured to detect one or more dishes positioned on a table, and in some embodiments, may detect what menu items (e.g., entrees, appetizers, etc.) are served on the one or more dishes. More specifically, in some embodiments, dish detection system 114 may identify, via, for example, a boosting algorithm, one or more regions of interest (ROI) on a table to identify one or more dishes on the table.

Further, in some embodiments, one or more cameras may be positioned proximate a restaurant kitchen (e.g., entrance) and may be configured to detected one or more menu items before and/or after being served. In these and other embodiments, a identifier (e.g., a table number on a paper) may be detected and may be used to determine a table associated with the one or more menu items. Alternatively or additionally, server movement (e.g., movement of a waiter/waitress) may be tracked to determine the table associated with the one or more menu items

In some embodiments, an output of dish detection module 114 may include a depiction (e.g., an image) of one or more dishes (e.g., on a table) with one more identifiers (e.g., bounding squares/boxes), wherein each dish on the table is associated with an identifier. More specifically, dish detection module 114 may output a depiction of one or more dishes including a shape (e.g., a square) around each depicted dish.

In some embodiments, data (e.g., visual data) for a menu item may be captured and used to monitor the quality of the menu item before the menu item is served to a customer. More specifically, for example, a chain restaurant may desire to monitor menu item quality before the menu item is served to a customer.

Further, in some embodiments, dish detection system 114 may be configured to determine, or generate data that may be used to determine, a rate at which a person consumes one or more food items on a dish. For example, via utilizing temporal information, higher-level representations, which may preserve and summarize local motion features of short frame sequences of a video, may be used to determine a rate at which a customer consumes one or more food items. More specifically, via a 3D convolutional neural network (CNN), temporal dynamics among sequential frames of a video may be used for learning an effective spatiotemporal video representation. Further, based on computing distance between finished and unfinished dish images, the speed of food consumption of a dish may be estimated. In contrast to traditional 2D CNN, a 3D CNN may provide information about the speed of food consumption (e.g., local motion feature) from the sequential frames, which may be used to estimate a degree of customer satisfaction with a menu item.

Person detection system 116 may be configured to receive video and/or image data (e.g., one or more video frames) (e.g., from one or more cameras) of an area of a restaurant (e.g., including a table) and detect one or more persons within the area (e.g., adjacent the table, such as sitting at the table). In some embodiments, person detection system 116 may be configured to utilize a support vector machine to determine whether one or more customers are within an area (e.g., adjacent the table). Further, person detection system 116 may be configured to estimate, via, for example, an age estimation algorithm (e.g., including a multi-scale convolutional network), an age of one or more customers within the area. Further, in some embodiments, person detection system 116 may be configured to detect emotions (e.g., positive and/or negative emotions) of a customer (e.g., as he/she consumes a menu item). Emotions may be detected via any suitable emotion and/or facial recognition technology.

POS system 104 may be configured to receive textual data related to one or more menu items (e.g., food) for an order placed at the table (e.g., via a server entering the order). Further, in some embodiments, POS system 104 may generate a vector representation of the textual data (e.g., via a word2vec model).

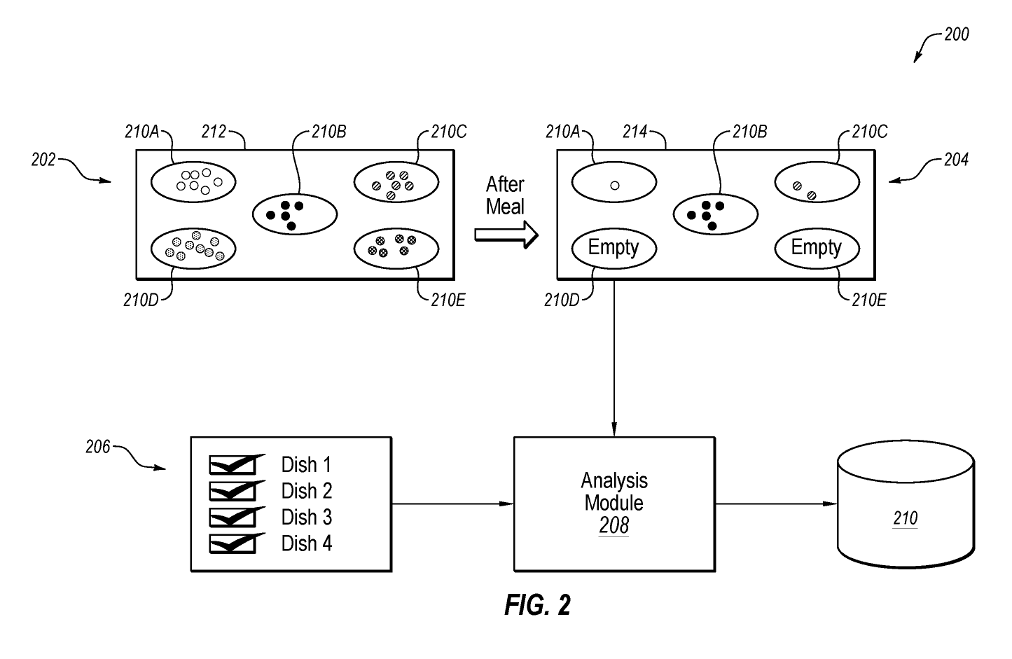

FIG. 2 depicts an example system 200 including visual data 202 and 204, textual data 206, an analysis module 208, and a database 210. For example, analysis module 208 may include fusion module 106, regression module 108, and/or review generating module 110 (see FIG. 1).

Visual data at block 212 depicts a plurality of dishes 210A-210E on a table, wherein each dish includes one or more menu items. Further, block 214 of visual data 204 illustrates the plurality of food dishes 210A-210E on the table ata subsequent time. More specifically, at block 214, dishes 210D and 210E are empty, and dishes 210A-210C have less food (e.g., less of a menu item) than shown at block 212. Further, dish 210B shown at block 214 has the approximately the same amount of food (e.g., the same amount of the menu item) as shown in block 212. Data associated with block 214 (e.g., image and video data) identifies how much of the menu items is leftover after one or more customers finish eating at the restaurant. More specifically, data associated with block 214 may show how much food was eaten and how much was leftover by the one or more customers.

Further, at block 216 of FIG. 2, textual data may include data identifying which one or more dishes were ordered at the table. Textual data from block 216 and visual data from block 214 may be provided to analysis module 208, which may generate one or more reviews of one or more menu items of dishes 210A-210E based on, for example, an amount of the menu items consumed. As described herein, other factors, such as emotions of a customer (e.g., positive or negative emotions) while consuming the one or more menu items, a rate of consumption of the menu items, whether or not the leftovers are taken out of the restaurant (e.g., wrapped/boxed up) up by a customer, etc. may be used to generate the one or more reviews.

Referring again to FIG. 1, fusion module 106 may be configured to receive data from visual detection system 102 and/or POS system 104. More specifically, fusion module 106 may receive visual data (e.g., image with identifiers (e.g., bounding boxes) for each dish at a table) from visual detection system 102.

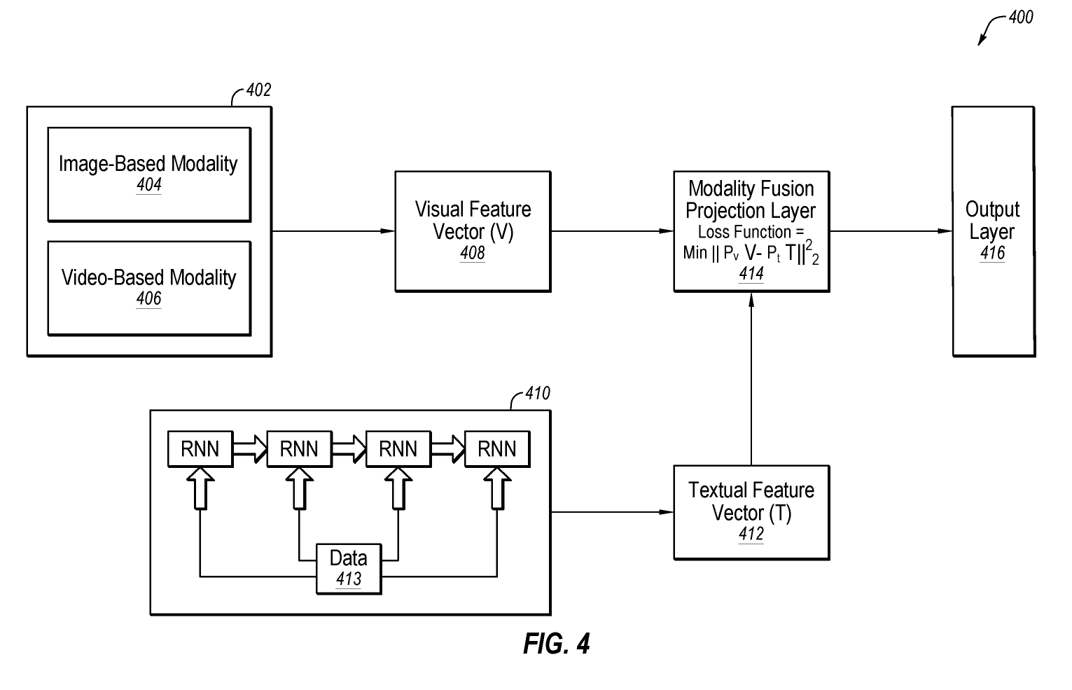

Fusion module 106 may also be configured to receive data from POS system 104, such as textual information indicative of one or more placed orders (e.g., taken by a server), and possible which customer ordered which menu item. For example, customers within an area (e.g., at a table) may be identified by their position within the area (e.g., at the table). In some embodiments, as described more fully below with reference to FIG. 4, fusion module 106 may receive a visual feature vector from surveillance system 102 and/or a textual feature vector from POS system 104

As described more fully herein, in some embodiments, fusion module 106 may be configured to fuse visual data (e.g., image data and/or video data) received from detection system 102 and textual data received from POS system 104. More specifically, in some embodiments, fusion module 106 may determine one or more linear mapping functions for video projections (Pᵥ) and textual projections (Pₜ), and measure a relationship between visual data and textual data in an embedding space by minimizing a loss function. In these and other embodiments, fusion module 106 may generate local optimal projections Pᵥ and Pₜ, which may be computed by, for example visual data-textual data pairs using a stochastic gradient descent algorithm. Upon obtaining the projections (Pᵥ and Pₜ), the visual data and textual data may be projected into a common embedding for modality fusion.

Further, in some embodiments, fusion module 106 may be configured to receive data related to an age of one more customers at a table, emotions of one or more customers, a rate of consumption of one or more items at the table, and/or whether the one or more customers took leftovers out of the restaurant. In these embodiments, data related to age, emotions, rate of consumption, and/or leftovers may be fused with visual data and/or textual data.

Regression module 108 may be configured to generate one or more models (e.g., math models) related to, for example, empty dishes (e.g., a dish without a menu item), fully loaded dishes (e.g., dishes will a full menu item prior to eating), and dishes after a customer has finished eating the menu item at the restaurant. More specifically, for example, regression module 108 may receive as an input a vector representation of data from one or more modalities (e.g., visual detection system 102 and POS system 104 of FIG. 1). Further, regression module 108 may output, based on one or more linear regressions, one or more models (e.g., math models) associated with a menu item.

More specifically, one or more regression processes (e.g., performed via regression module 108) may be result in one or more models (e.g., math models) as reference. For example, one regression process may generate a model for an empty dish, and another regression process may generate a model for a full dish (e.g., a full dish before being served to a customer). In addition, another regression process may generate a model for dish after the customer has finished eating the menu item at the restaurant. This model may represent, for example, a partially eaten menu item or a fully eaten menu item.

Further, based on regression models, and possibly other data (e.g., age of consumers, customer emotions, rate of consumption, leftovers retained (e.g., taken out of the restaurant), review generation module 110 may generate on or more score and/or reviews of a restaurant and/or one or more menu items served by the restaurant. More specifically, a model for dish after the customer has finished eating the menu item at the restaurant may be compared to each of a model for an empty dish and a model for a full dish to determine how much or how little a customer consumed. This information may be used in generating a score and/or a review for the menu item.

Further, according to some embodiments, visual data (e.g., age of consumers, customer emotions, rate of consumption, leftovers retained) may be used to adjust and/or recommend portion sizes (e.g., small, medium or large order sizes). Portion sizes may be related to prices, and thus, various embodiments may be utilized to save customers and/or a restaurant money.

In some embodiments, social media data may be used in rating and/or ranking menu items. For example, by tracking social media data (e.g., review and/or comments from social media (e.g., Facebook™ or Yelp™), customer ratings may be used in rating and/or ranking menu items. Further, photos, for example, uploaded by customers may be used to identify which dishes customers like and/or comment about. In addition, via tracking a name of a menu item mentioned in a comment, an analysis may be used to identify and determine customer opinions about a menu item (e.g., a score, such as a positive score, a neutral score, a negative score, etc.).

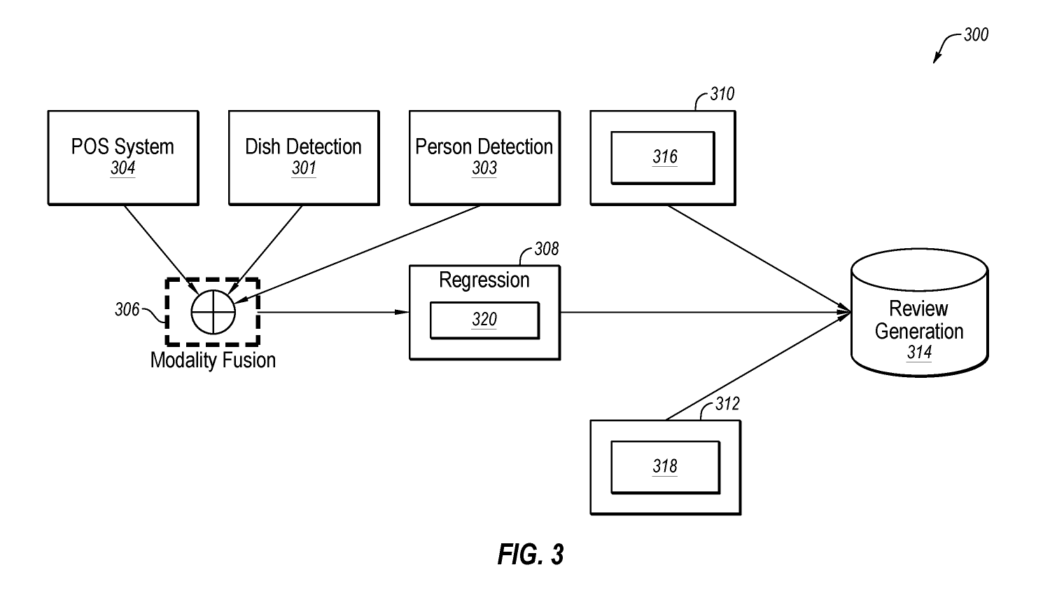

FIG. 3 illustrates an example system 300, arranged in accordance with one or more embodiments disclosed herein. System 300 includes a dish detection system 301, a person detection system 303, and a POS system 304. Dish detection system 301 may include or may be part of dish detection system 114 (see FIG. 1), person detection system 303 may include or may be part of person detection system 116 (see FIG. 1), and POS system 304 may include or may be part of POS system 104 (see FIG. 1). System 300 further includes a fusion module 306, a regression modules 308, 310, and 312, and review generation module 314. Regression module 308, 310, and 312 may include or may be part of regression module 308 (see FIG. 1), and review generation module 314 may include or may be part of review generation module 110 (see FIG. 1).

In this embodiment, regression module 310 may include a model of an empty dish and regression module 312 may include a model of a dish including a menu item prior to consumption (e.g., a full dish). Stated another way, regression module 312 may include a model of dish with a full menu item. Model 316 of regression module 310 may be referred to as a highest score model (e.g., having a score of 1), and model 318 of regression module 312 may be referred to as a lowest score model (e.g., having a score of 0).

Regression module 308 may be configured to generate a model 320 (e.g., a math model) related to, a dish of a menu item after a customer has finished eating the menu item at the restaurant. More specifically, for example, regression module 308 may receive as an input a vector representation of data from one or more modalities (e.g., visual detection system 102 and POS system 104 of FIG. 1). Further, regression module 308 may output, based on one or more linear regressions, model 320.

In some embodiments, a fast interpolation method may be used to estimate a score of a menu item dish based on a comparison of model 320 to model 316 and/or model 318. More specifically, for example, review generation module 314 may receive model 316, model 318, and model 320. Further, based on a comparison of model 316, model 318, and model 320, a score for the menu item dish (e.g., a score between 0 and 1, wherein the closer the score is to 1, the better the score) may be generated. For example, review generation module 314 may calculate a distance of functions and transform (e.g., normalize) the distance into a real value score based on models 316 and 318 as references. If a distance between model 320 of the menu item dish and the model 316 of an empty dish is short, the score of the menu item dish may be relatively high. In contrast, if a distance between model 320 of the menu item dish and model 316 of an empty dish is long, the score of the menu item dish may be relatively low.

After obtaining a score for a plurality of menu items, a ranking of the menu items in a restaurant based on the scores may be generated (e.g., via review generation module 314). In some embodiments, a review may be automatically generated in response to a predefined question. For example, the question “what are the most popular dishes?” may be answered via a review, or may cause generation of a review, wherein the review may include a ranking of menu items based on menu items scores. In addition, according to some embodiments the question “what are the most popular dishes for seniors?” may be answered via another review, or may cause generation of another review, wherein this review may include a ranking of menu items based on menu items scores for seniors.

FIG. 4 is a diagram of an example flow 400 that may be used to determine a loss function for determining a relationship between visual data and textual data, according to at least one embodiment described herein. In some embodiments, the flow 400 may be configured to illustrate a process for determining a relationship between visual and textual data. In these and other embodiments, a portion of the flow 400 may be an example of the operation of visual detection system 102, POS system 104, and/or fusion module 106 FIG. 1.

The flow 400 may begin at block 402, wherein based on visual data (e.g., video data and/or image data), a visual feature vector 408 may be generated. More specifically, for example, via one or more neural networks (e.g., a convolutional neural network (CNN) and/or a 3D neural network), visual feature vector 408 may be generated from one or more images from an image-based modality 404 and/or one or more videos from a video-based modality 406. Stated another way, via, for example, feature extraction of one or more images and/or videos, visual feature vector 408 may be generated.

At block 410, based on textual data, a textual feature vector 412 may be generated. More specifically, for example, based on recurrent neural network (RNN), visual texture feature vector 412 may be generated from data 413, which may include, for example, point of sale data and/or social network data (e.g., online reviews).

At block 414, a loss function based on visual feature vector 408 and texture feature vector 412 may be determined and conveyed to an output 416, which may include, for example, a regression module (e.g., regression module 108 of FIG. 1). More specifically, for example, the loss function may be determined based on the following equation:

Min∥PᵥV−PₜT|²₂; (1)

wherein Pᵥ is a projection for the visual data, V is the visual feature vector, Pₜ is a projection for the textual data, and T is the textual feature vector.

Modifications, additions, or omissions may be made to the flow 400 without departing from the scope of the present disclosure. For example, the operations of flow 400 may be implemented in differing order. Furthermore, the outlined operations and actions are only provided as examples, and some of the operations and actions may be optional, combined into fewer operations and actions, or expanded into additional operations and actions without detracting from the essence of the disclosed embodiments. In short, flow 400 is merely one example of data flow for determining a relationship between visual and textual data and the present disclosure is not limited to such.

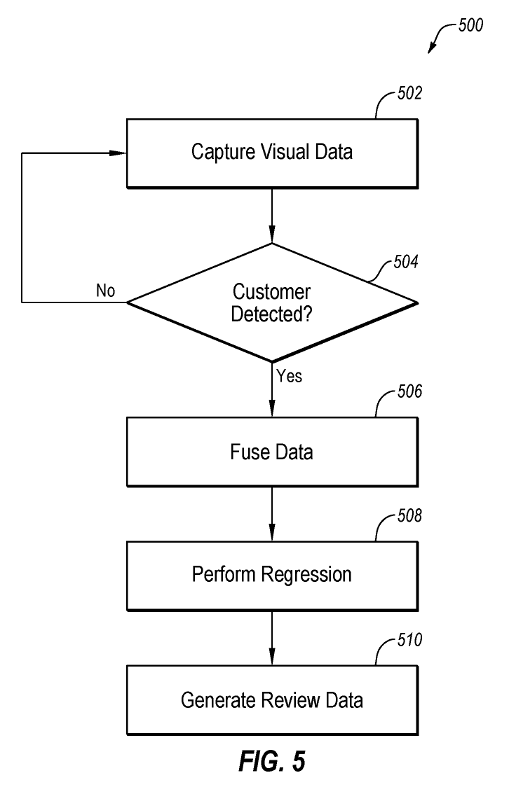

FIG. 5 shows an example flow diagram of a method 500 of generating one or reviews of a restaurant and/or items served at the restaurant, arranged in accordance with at least one embodiment described herein. Although illustrated as discrete blocks, various blocks may be divided into additional blocks, combined into fewer blocks, or eliminated, depending on the desired implementation.

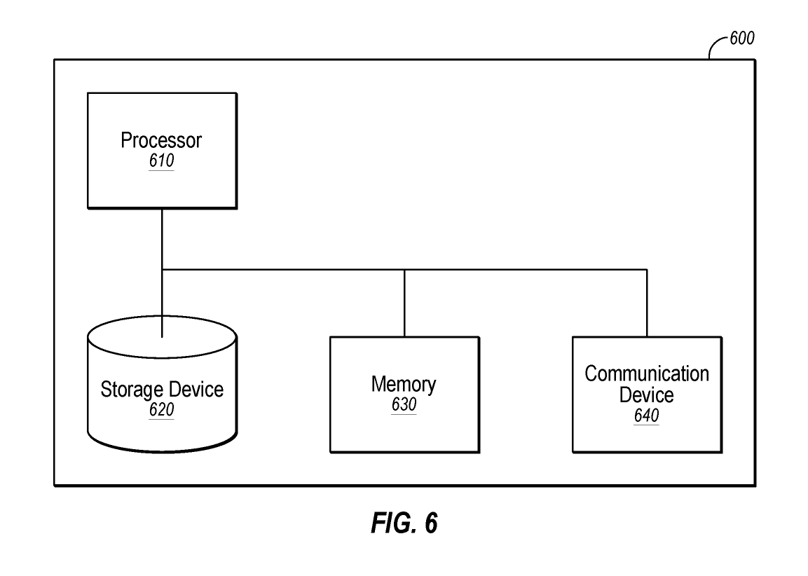

In some embodiments, method 500 may be performed by one or more devices, such system 100 of FIG. 1, system 200 of FIG. 2, system 300 of FIG. 3, and/or system 600 of FIG. 6. For instance, processing device 620 of FIG. 6 may be configured to execute computer instructions stored on memory 630 to perform functions and operations as represented by one or more of the blocks of method 500.

Method 500 may begin at block 502. At block 502, visual data (e.g., image and/or video data) may be captured, and method 500 may proceed to block 504. For example, one or more cameras positioned within an eating establishment (e.g., a restaurant, bar, etc.) may capture data, such as one or more images, one or more videos, or any combination thereof. For example, one or more of cameras 113 may capture image and/or video data within a restaurant.

At block 504, a determination as to whether a party including one or customers (e.g., within an area of a restaurant) has been detected. For example, via one or more cameras (e.g., one or more surveillance cameras positioned in a restaurant) (e.g., cameras 113 of FIG. 1), a determination as to whether a party including one or more customers is proximate a table within the restaurant. If a party is detected, method may proceed to block 506. If a party is not detected, method may return to block 502.

At block 506, data, such as visual data and textual data, may be fused to determine a relationship between the video data and the textual data. For example, visual data received via visual detection system 102 of FIG. 1 may be fused with textual data received via POS system 104 of FIG. 1. The visual data may include data related to, for example, one or more dishes positioned on the table and/or customers (e.g., emotions, age, etc.) positioned proximate the table. In some embodiments, a loss function may be generated to determine a relationship (or lack thereof) between the visual data and the textual data. For example, fusion module 106 (see FIG. 1) and/or processor 610 (see FIG. 6) may fuse visual data and textual data.

At block 508, a regression process may be performed to generate a model of one or more plates at the table. A model of each plate may be indicative of how much of a menu item a customer has consumed after the customer has finished his/her meal. For example, regression module 108 (see e.g. FIG. 1) and/or processor 610 (see FIG. 6) may generate a model of one or more plates at the table.

At block 510, one or more reviews may be generated. For example, a score for each menu item at the table based on a comparison of the model of the menu item dish to one or more other models (e.g., model 316 and model 318 of FIG. 3). More specifically, for example, review generation module 314 (see FIG. 2) may receive model 316, model 318, and a model of the menu item dish after a customer has finished eating the menu item menu. Further, based on a comparison of model 316, model 318, and a model of the menu item dish, a score for the menu item dish (e.g., a score between 0 and 1) may be generated. In some embodiments, the comparison may be used to determine how much of the menu item was consumed by the customer. In some embodiments, a fast interpolation process may be used to estimate a score of a menu item dish. For example, review generating module 110 (see FIG. 1) and/or processor 610 (see FIG. 6) may generate one or more reviews.

Modifications, additions, or omissions may be made to method 500 without departing from the scope of the present disclosure. For example, the operations of method 500 may be implemented in differing order. Furthermore, the outlined operations and actions are only provided as examples, and some of the operations and actions may be optional, combined into fewer operations and actions, or expanded into additional operations and actions without detracting from the essence of the disclosed embodiment.

According to various embodiments disclosed herein, textual information (e.g., from a POS) and visual information (e.g., from one or more camera) may be fused, providing an accurate and statistical analysis based on text information and visual information. Further, one or more reviews may be automatically generated based on the fused data. Various embodiments may utilize visual information to generate and/or trains a robust model for detection and recognition. Various embodiments may be easily implemented (e.g., due to restaurants already having cameras and/or POS systems).

FIG. 6 is a block diagram of an example computing system 600, in accordance with at least one embodiment of the present disclosure. For example, system 100 (see FIG. 1), system 200 (see FIG. 2), system 300 (see FIG. 3), system 400 (see FIG. 4), or one or more components thereof, may be implemented as computing system 600.

Computing system 600 may include a desktop computer, a laptop computer, a server computer, a tablet computer, a mobile phone, a smartphone, a personal digital assistant (PDA), an e-reader device, a network switch, a network router, a network hub, other networking devices, or other suitable computing device.

Computing system 600 may include a processor 610, a storage device 620, a memory 630, and a communication device 640. Processor 610, storage device 620, memory 630, and/or communication device 640 may all be communicatively coupled such that each of the components may communicate with the other components. Computing system 600 may perform any of the operations described in the present disclosure.

In general, processor 610 may include any suitable special-purpose or general-purpose computer, computing entity, or processing device including various computer hardware or software modules and may be configured to execute instructions stored on any applicable computer-readable storage media. For example, processor 610 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 6, processor 610 may include any number of processors configured to perform, individually or collectively, any number of operations described in the present disclosure.

In some embodiments, processor 610 may interpret and/or execute program instructions and/or process data stored in storage device 620, memory 630, or storage device 620 and memory 630. In some embodiments, processor 610 may fetch program instructions from storage device 620 and load the program instructions in memory 630. After the program instructions are loaded into memory 630, processor 610 may execute the program instructions.

For example, in some embodiments one or more of the processing operations of a device and/or system (e.g., an application program, a server, etc.) may be included in data storage 620 as program instructions. Processor 610 may fetch the program instructions of one or more of the processing operations and may load the program instructions of the processing operations in memory 630. After the program instructions of the processing operations are loaded into memory 630, processor 610 may execute the program instructions such that computing system 600 may implement the operations associated with the processing operations as directed by the program instructions.

Storage device 620 and memory 630 may include computer-readable storage media for carrying or having computer-executable instructions or data structures stored thereon. Such computer-readable storage media may include any available media that may be accessed by a general-purpose or special-purpose computer, such as processor 610. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause processor 610 to perform a certain operation or group of operations.

In some embodiments, storage device 620 and/or memory 630 may store data associated with a review system. For example, storage device 620 and/or memory 630 may store models, visual data, textual data, and/or reviews.

Communication device 640 may include any device, system, component, or collection of components configured to allow or facilitate communication between computing device 600 and another electronic device. For example, communication device 640 may include, without limitation, a modem, a network card (wireless or wired), an infrared communication device, an optical communication device, a wireless communication device (such as an antenna), and/or chipset (such as a Bluetooth device, an 802.6 device (e.g. Metropolitan Area Network (MAN)), a Wi-Fi device, a WiMAX device, cellular communication facilities, etc.), and/or the like. Communication device 640 may permit data to be exchanged with any network such as a cellular network, a Wi-Fi network, a MAN, an optical network, etc., to name a few examples, and/or any other devices described in the present disclosure, including remote devices.

Modifications, additions, or omissions may be made to FIG. 6 without departing from the scope of the present disclosure. For example, computing system 600 may include more or fewer elements than those illustrated and described in the present disclosure. For example, computing system 600 may include an integrated display device such as a screen of a tablet or mobile phone or may include an external monitor, a projector, a television, or other suitable display device that may be separate from and communicatively coupled to computing system 600.

As used herein, the terms “module” or “component” may refer to specific hardware implementations configured to perform the operations of the module or component and/or software objects or software routines that may be stored on and/or executed by, for example, video detection system 102, POS system 104, fusion module 106, regression module 108, and/or review generation module 110. In some embodiments, the different components and modules described herein may be implemented as objects or processes that execute on a computing system (e.g., as separate threads). While some of the system and methods described herein are generally described as being implemented in software (stored on and/or executed by system 600), specific hardware implementations or a combination of software and specific hardware implementations are also possible and contemplated. In this description, a “computing entity” may include any computing system as defined herein, or any module or combination of modules running on a computing device, such as system 600.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, etc.) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated. In the present disclosure, a “computing entity” may be any computing system as previously defined in the present disclosure, or any module or combination of modulates running on a computing system.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A method, comprising:
detecting, via at least one processor, a dish including at least one menu item served to one or more customers in a restaurant;
receiving, at the at least one processor, visual data including at least one of an image and a video of the dish after the one or more customers have finished eating the at least one menu item at the restaurant;
generating, via the at least one processor, a model for the dish based on the received visual data;
determining, via the at least one processor, a score for the at least one menu item based on a comparison of the generated model to one or more other stored models associated with the at least one menu item; and
generating, via the at least one processor, one or more reviews for the at least one menu item based at least partially on the determined score for the at least one menu item.

2. The method of claim 1, further comprising:
receiving, at the at least one processor, textual data related to the at least one menu item ordered by the one or more customers; and
measuring, via the at least one processor, a relationship between the textual data and the visual data.

3. The method of claim 1, further comprising capturing the visual data via one or more surveillance cameras positioned in the restaurant.

4. The method of claim 1, wherein determining the score further includes determining the score based on one or more detected emotions of the one or more customers while the one or more customers consumed the at least one menu item.

5. The method of claim 1, wherein determining the score further includes determining the score based on a rate of consumption of the at least one menu item by the one or more customers.

6. The method of claim 1, further comprising:
detecting, via the at least one processor, the one or more customers via a supervised learning model; and
estimating an age of at least one customer of the one or more customers via a multi-scale convolutional network;
wherein generating one or more reviews comprises generating one or more age-based reviews.

7. The method of claim 1, wherein determining the score for the at least one menu item based on the comparison of the generated model to one or more other stored models comprises comparing the model for the dish to at least one of a model for a full dish and a model for an empty dish.

8. A system, comprising:
one or more processors configured to:
detect a dish including at least one menu item served to one or more customers in a restaurant;
receive visual data including at least one of an image and a video of the dish after the one or more customers have finished eating the at least one menu item at the restaurant;
generate a model for the dish based on the received visual data;
determine a score for the at least one menu item based on a comparison of the generated model to one or more other stored models associated with the at least one menu item; and
generate one or more reviews for the at least one menu item based at least partially on the determined score for the at least one menu item.

9. The system of claim 8, wherein the one or more processors are further configured to:
receive textual data related to the at least one menu item ordered by the one or more customers; and
measure a relationship between the textual data and the visual data.

10. The system of claim 8, wherein the one or more processors are further configured to determine the score based on a rate of consumption of the at least one menu item by the one or more customers.

11. The system of claim 8, wherein the one or more processors are further configured to determine the score based on one or more detected emotions of the one or more customers while the one or more customers consumed the at least one menu item.

12. The system of claim 8, wherein the one or more processors are further configured to:
detect the one or more customers via a supervised learning model; and
estimate an age of at least one customer of the one or more customers via a multi-scale convolutional network;
wherein the one or more reviews comprise one or more age-based reviews.

13. The system of claim 8, wherein the one or more processors are further configured to:
generate a model for a full dish; and
generate of model for an empty dish.

14. The system of claim 13, wherein the one or more other stored models comprises the model for the full dish and the model for the empty dish.

15. A non-transitory computer-readable medium having computer instructions stored thereon that are executable by a processing device to perform or control performance of operations comprising:
detecting a dish including at least one menu item served to one or more customers in a restaurant;
receiving visual data including at least one of an image and a video of the dish after the one or more customers have finished eating the at least one menu item at the restaurant;
generating a model for the dish based on the received visual data;
determining a score for the at least one menu item based on a comparison of the generated model to one or more other stored models associated with the at least one menu item; and
generating one or more reviews for the at least one menu item based at least partially on the determined score for the at least one menu item.

16. The non-transitory computer-readable medium of claim 15, the operations further comprising:
receiving textual data related to the at least one menu item ordered by the one or more customers; and
measuring a relationship between the textual data and the visual data.

17. The non-transitory computer-readable medium of claim 15, wherein determining the score further includes determining the score based on one or more detected emotions of the one or more customers while the one or more customers consumed that at least one menu item.

18. The non-transitory computer-readable medium of claim 15, wherein determining the score further includes determining the score based on a rate of consumption of the at least one menu item by the one or more customers.

19. The non-transitory computer-readable medium of claim 15, the operations further comprising:
detecting the one or more customers via a supervised learning model; and
estimating an age of at least one customer of the one or more customers via a multi-scale convolutional network;
wherein generating one or more reviews comprises generating one or more age-based reviews.

20. The non-transitory computer-readable medium of claim 15, wherein determining the score for the at least one menu item based on the comparison of the generated model to one or more other stored models comprises comparing the model for the dish to at least one of a model for a full dish and a model for an empty dish.
